(19) United States
(12) Patent Application Publication
(10) Pub. No.: US 2025/0086087 A1
(43) Pub. Date: Mar. 13, 2025

(54) APPLICATION PERFORMANCE EVALUATION WITH DUAL MODEL

(71) Applicant: INTERNATIONAL BUSINESS MACHINES, Armonk, NY (US)

(72) Inventors: Ying MO, Beijing (CN); Wu DI, Beijing (CN); Xing TIAN, Beijing (CN); Qing Zhi YU, Beijing (CN); Nan CHEN, Beijing (CN); Ju Ling LIU, Beijing (CN)

(21) Appl. No.: 18/462,503

(22) Filed: Sep. 7, 2023

(51) Int. Cl. G06F 11/34; G06F 11/36

(52) U.S. Cl. CPC G06F 11/3457; G06F 11/3688; G06F 11/3698

(57) ABSTRACT

Computer implemented methods, systems, and computer program products include program code executing on a processor(s) obtain factor(s) relevant to a given resource. The program code determines relationships between the factor(s). Based on parameters comprising the relationships, the program code identifies, from a search space, configuration(s) for resource(s) and configuration(s) for workload(s) in the computing environment. The program code executes, based on a pre-defined policy, a test: a workload configured according to a configuration in a system under test instance configured according to a configuration. The program code obtains performance measurements for the test in the system under test instance. The program code utilizes the performance measurements to update a known data set.

### BACKGROUND

The present invention relates generally to the field of performance modeling and more specifically to performance modeling for accurate and efficient prediction and implementation of resources in computing systems.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

Machine learning systems are often tasked with not only making various decisions (e.g., predictions), but also to provide transparency to users so that the users can understand the logic behind the output. There are tradeoffs related to providing this transparency or interpretability as models with greater accuracy offer less interpretability and vice versa. Certain machine learning models (which are part of machine learning systems) are referred to as black-box models while others are called white-box models. A black-box model offers more accuracy with less interpretability while white-box models offer more interpretability and less accuracy. Black-box models include, but are not limited to, neural networks (NNs), gradient boosting models, and/or complicated ensembles. Due to the complex nature of these models, their inner workings are harder to understand, and the output does not include indicators (e.g., estimates) for the importance of each feature in the model's output (e.g., prediction). Additionally, the interaction between the various features that comprise these models can be difficult to comprehend. White-box machine learning models include, but are not limited to, linear regression and/or decision trees. White-box models do not have the predictive capacity of black-box models and white-box models, unlike black-box models, are not always capable of modelling the inherent complexity of a dataset (e.g., feature interactions). However, the output of the models (e.g., predictions) are easier to explain and to interpret.

### SUMMARY

Shortcomings of the prior art are overcome, and additional advantages are provided through the provision of a computer-implemented method for predicting optimal configurations for deploying a given resource in a computing environment. The method can include: obtaining, by one or more processors, one or more factors relevant to the given resource; determining, by the one or more processors, relationships between the one or more factors; based on parameters comprising the relationships, identifying, by the one or more processors, from a search space, one or more configurations for at least one resource and one or more configurations for at least one workload in the computing environment; executing, by the one or more processors, based on a pre-defined policy, a test, wherein the test executes a workload configured according to a configuration of the one or more for the at least one workload in a system under test instance configured according to a configuration of the one or more configurations for at the least one resource; obtaining, by the one or more processors, performance measurements for the test in the system under test instance; and utilizing, by the one or more processors, the performance measurements to update a known data set.

Shortcomings of the prior art are overcome, and additional advantages are provided through the provision of a computer program product for predicting optimal configurations for deploying a given resource in a computing environment. The computer program product comprises a storage medium readable by a one or more processors and storing instructions for execution by the one or more processors for performing a method. The method includes, for instance: obtaining, by the one or more processors, one or more factors relevant to the given resource; determining, by the one or more processors, relationships between the one or more factors; based on parameters comprising the relationships, identifying, by the one or more processors, from a search space, one or more configurations for at least one resource and one or more configurations for at least one workload in the computing environment; executing, by the one or more processors, based on a pre-defined policy, a test, wherein the test executes a workload configured according to a configuration of the one or more for the at least one workload in a system under test instance configured according to a configuration of the one or more configurations for at the least one resource; obtaining, by the one or more processors, performance measurements for the test in the system under test instance; and utilizing, by the one or more processors, the performance measurements to update a known data set.

Shortcomings of the prior art are overcome, and additional advantages are provided through the provision of a system for predicting optimal configurations for deploying a given resource in a computing environment. The system includes: a memory, one or more processors in communication with the memory, and program instructions executable by the one or more processors via the memory to perform a method. The method includes, for instance: obtaining, by the one or more processors, one or more factors relevant to the given resource; determining, by the one or more processors, relationships between the one or more factors; based on parameters comprising the relationships, identifying, by the one or more processors, from a search space, one or more configurations for at least one resource and one or more configurations for at least one workload in the computing environment; executing, by the one or more processors, based on a pre-defined policy, a test, wherein the test executes a workload configured according to a configuration of the one or more for the at least one workload in a system under test instance configured according to a configuration of the one or more configurations for at the least one resource; obtaining, by the one or more processors, performance measurements for the test in the system under test instance; and utilizing, by the one or more processors, the performance measurements to update a known data set.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is a workflow that provides an overview of various aspects performed by the program code (executing on one or more processors) in some embodiments of the present disclosure;

FIG. 3 is an example of a performance model and its functionality in accordance with various aspects of some examples herein;

FIG. 4 is an example of a performance model and its functionality in accordance with various aspects of some examples herein;

FIG. 5 is an example of a performance model and its functionality in accordance with various aspects of some examples herein;

FIG. 6 is an example of a performance model and its functionality in accordance with various aspects of some examples herein;

FIG. 7 is an example of a performance model and its functionality in accordance with various aspects of some examples herein;

FIG. 8 is an example of a performance model and its functionality in accordance with various aspects of some examples herein;

FIG. 9 is an example of a data flow in performance model in accordance with various aspects of some examples herein; and

FIG. 10 is an example of a data flow in performance model in accordance with various aspects of some examples herein.

### DETAILED DESCRIPTION

Embodiments of the present invention include computer-implemented method, computer program products, and computer systems, where program code executing on one or more processors generates and applies a performance model that reflects a relationship between different factors and resources in a computing system and the performance impact of these factors and resources. The program code applies this model to predict resource or supported workload requirements for various actions within the system (including installation of new applications, services, resources, etc.), where the various actions include specific performance criteria.

When a new resource (software, hardware, application, service, etc.) is installed or deployed in a computing environment, one prepares the environments such that the resource will perform effectively and efficiently upon installation or deployment. Many computing systems employ complex architectures such as distributed environments and cloud computing environments and thus, anticipating the requirements and impacts of the addition of a new resource can be complex. For example, users (administrators, customers, etc.) will want to know how many resources they should prepare before installing an application. Some applications can have specific characteristics, so it becomes challenging to evaluate performance, which could include building a performance prediction model, determining a cost to the host environment of deploying the application, and running tests against the environment to make this determination. Because the host environments could be large and many applications have short release cycles, even if these complex calculations and tests can be completed, the data returned could become stale even when first returned. Another challenge in understanding the impact of deploying a new resource into a technical environment is that if the resource is a complex application, understanding all aspects in the environment to prepare for the deployment can be challenging as the application can impact resource utilization, and workload distribution, but the relationships between these aspects can also change based on the deployment. Utilizing a white-box view to measure performance does not provide a view of these relationships and without an understanding of the relationships, testing scenarios in a meaningful way to prepare for a deployment is not possible. As will be described herein, embodiments of the present invention address these challenges to provide a fuller view of aspects in a system impacted by the deployment of a new or updated resource, such as an application, and the relationships between these aspects.

As discussed above, white-box models and black-box models differ in the interpretability and accuracy that they can offer when providing predictions, including those related to resources to prepare for the deployment of a new or updated resource, such as an application. Some existing systems that provide insight into computing infrastructures are white-box models. These models can provide knowledge on how a system or part of the system performs based on certain factors. Examples herein utilize portions of these models to generate a model to predict performance for a whole system. White-box models also do not provide insights into all factors that could impact the performance of a system when a new or updated resource is deployed. The examples herein extend these insights while providing a white-box view rather than a black-box view, meaning that interpretability is provided despite the model generated in the examples herein providing predictions in complex scenarios that are presently reserved for black-box models in existing systems.

Examples herein (computer-implemented methods, computer program products, and computer systems) include program code executed by one or more processor that: 1) builds a performance model to reflect the relationship between different factors as well as the performance impact of deploying a new or updated resource; and 2) utilizes the model to predict resources or supported workloads given specified performance criteria of the new or updated resource. Examples herein utilize a test job scheduler to minimize a cost of building the model. Using the job scheduler enables the program code to minimize resources used, minimize a number of tests run, and minimize the time spent on these tests, while keeping the model accuracy within an acceptable range (the acceptable range can be a pre-defined or pre-determined value). For example, program code in embodiments of the present invention can run performance tests in parallel; the program code utilizes a scheduler to optimize the test to maximize the use of test environments. To generate an accurate and efficient performance model, in the examples, the program code generates the performance model as a dual model, meaning that the program code utilizes both black-box and white-box knowledge to build the model. The program code can also manage the model lifecycle by using versions co-related to resource (e.g., application) releases, tracking release history, and auto-detecting drift continuously (e.g., release by release).

Example herein provide various advantages over existing approaches for one or more of prediction, visualization, and implementation of workload performance in computing systems. The examples described herein are cost-effective, accurate and adaptive. Additionally, program code in embodiments of the present invention can identify optimal resource requirements or workload distribution that satisfies the performance criteria by utilizing, in some examples, an acquisition function is used to determine the optimal combination of factors for the next round of performance tests. The efficiency of testing is improved through the use of the examples herein because the program code runs performance tests in parallel and optimizes them with a scheduler to maximize the use of test environments. The program code generates and applies an optimized performance model that can predict resource requirements or the maximum supported workload for a resource being deployed based on the performance criteria of the resource. The predictive capabilities enable customers to evaluate the resource needs before deployment of the new resource (e.g., software).

Embodiments of the present invention are inextricably linked to computing and the elements comprising these embodiments are integrated into a practical application. The examples herein are inextricably linked to computing at least because they utilize machine learning to address a challenge that is unique to computing, i.e., managing the deployment of a resource (application, resource, software, hardware, service, container, etc.) into a technical computing infrastructure. Embodiments of the present invention predict the impacts of this deployment to enable the existing resources to be efficiently and effectively prepared for the deployment. Thus, based on the predictions modeled by the examples herein, when the application is deployed, the resources, workloads, etc., in the environment can continue to operate efficiently. The efficient operation of a technical environment and the continuity of the environmental resources in view of the deployment of new and updated resources is a practical application. Thus, embodiments of the present invention provide a computing-based approach to a computing-specific challenge and benefit the technical architecture of a computing environment in a practical manner.

Embodiments of the present invention provide significant advantages over existing systems for preparing a technical environment for resource deployment. Unlike some existing approaches, some embodiments of the present invention optimize the testing of the technical environment in advance of deployment by utilizing an acquisition function to determine an optimal combination of factors for a next round of performance tests. These performance tests enable the program code, when applying a performance model, to determine optimal resource requirements or workload distributions that satisfy performance criteria of the new resource being deployed in the environment. Some existing approaches are unable to assess resource requirements or a maximum supported workload for a new resource, while in embodiments of the present invention the program code can apply a performance model to predict these aspects. This predictive capability helps customers evaluate the resource needs before software deployment. As will be discussed in greater detail herein, embodiments of the present invention leverage advantages of both black-box and white-box model knowledge to achieve accuracy without compromising performance. Examples herein embed white-box knowledge into a black-box model. The program code can build the model it applies more efficiently at least because the integration of the white-box model properties provides transparency which enables convergence of the searching process for the optimal values more quickly. The examples herein execute fewer tests than existing approaches but these fewer tests can detect performance model drifts, compare the predicted performance generated by the model and the actual performance collected from the running application, co-relate the model to the resource (e.g., software releases), and/or track the model accuracy continuously to ensure it is always up-to-date. Through the decreased testing, the examples herein can minimize the cost of test efforts while keeping the accuracy of the performance model within an acceptable range.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

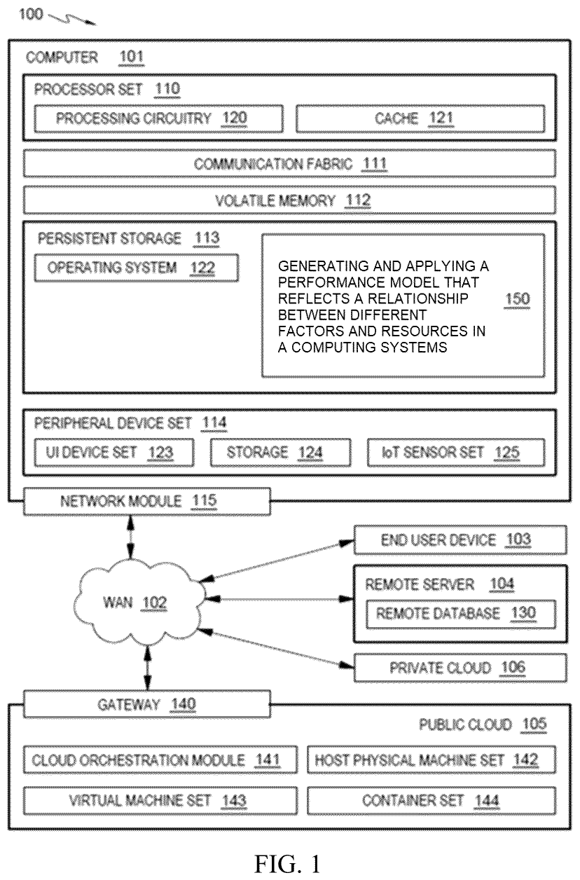

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for generating and applying a performance model that reflects a relationship between different factors and resources in a computing system and the performance impact of these factors and resources including when a new resource is deployed to the computing system 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the present invention include computer-implemented methods, computer program products, and computer systems where program code executing on one or more processors builds and applied a model for performance prediction. The program code applies the model in advance of deploying a new resource (where the resource has known performance requirements) into a computing environment. In some examples, the program code encapsulates white-box knowledge inside a liner model with the hyper parameters in place to reflect how the system or some component in the system performs per certain factors. The program code can utilize an acquisition function to provide white-box knowledge to the black-box model. Hence, the program code generates and applies a dual model (combined white and black-box models) and can generate the model both in the presence or absence of hyper parameters for the white-box model. The program code improves the model, iteratively, through utilization (as it is a machine learning model). Program code in examples herein: 1) builds a performance model to reflect the relationship between different factors and the performance impacts; 2) utilizes the performance model to predict resource requirements or supported workloads given user-specified performance criteria; 3) minimizes testing costs related to determining factors related to resource deployment by limiting the use of resources, the number of test runs, and the time spent on testing; 4) utilizes a dual performance model to combine both black-box and white-box knowledge together to build a more accurate model more efficiently; and 5) manages the model lifecycle using versions co-related to the resource (e.g., software releases), tracks its history, and auto-detects drift continuously, including release by release. Regarding the testing aspect, the program code runs load tests in parallel against an environment pool (to optimize time considerations), and schedules load tests against the environment pool in an optimal way (e.g., by running tests in the same environment as much as possible) (to optimize resource use).

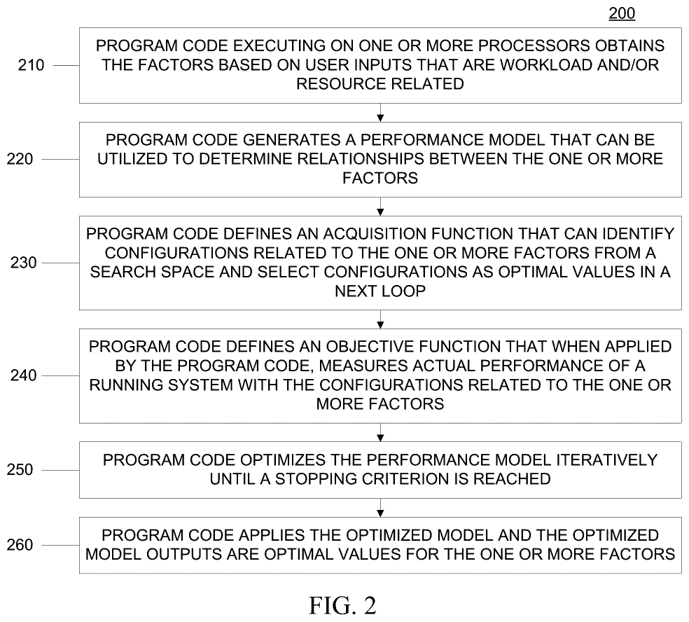

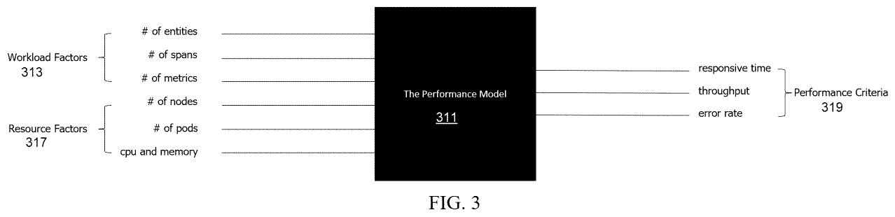

FIG. 2 is a general workflow 200 that illustrates various aspects of some examples. These aspects are elaborated upon herein and further illustrated in additional figures. In some examples herein, the program code executed by one or more processors generates a performance model that defines one or more relationships between different factors and identifies performance impacts of the one or more relationships. As illustrated in FIG. 2, in some examples, program code executing on one or more processors can obtain the factors based on user inputs that are workload and/or resource related (210). The program code also obtains performance criteria, which can be user-defined. Because the program code obtains certain values (e.g., factors, performance criteria), based on these values, the program code can provide optimal values for other factors to satisfy the defined performance criteria. FIG. 3 illustrates certain inputs into the performance model 311. The factors in this example include workload factors 313 (e.g., number of entities, number of spans, number of metrics, etc.) and resource factors 317 (e.g., number of nodes, number of pods, computer processing unit(s) (CPU) and memory, etc.). The performance criteria 319 can include response time, throughput, and error rate. The performance criteria 319 can refer to criteria that is desired after deployment of a new resource (e.g., software, hardware, application) into a computing environment (as described, in part, by the workload factors 313 and resource factors 317).

Returning to FIG. 2, the program code generates a performance model 311 (e.g., as a black-box) that can be utilized to determine relationships between the one or more factors (e.g., see, FIG. 3, the workload factors 313 and resource factors 317 and the performance criteria 319) (220). Some examples utilize Bayesian optimization. The program code defines an acquisition function that can identify configurations related to the one or more factors (e.g., workload and/or resource configurations) from a search space and select these configurations as optimal values in a next loop (230). When the program code applies the acquisition function, it returns a value that represents an expected improvement that could be gained by sampling a certain point in the search space. In some examples, higher values correspond to more promising points to sample. The program code defines an objective function that when applied by the program code, measures actual performance of a running system with the configurations related to the one or more factors (e.g., workload and/or resource configurations) identified by the acquisition function (240). The program code optimizes the performance model iteratively until a stopping criterion is reached (250). Stopping criteria can include, but is not limited to, a maximum number of iterations or a convergence threshold. The program code applies the optimized model and the optimized model outputs are optimal values for the one or more factors (260).

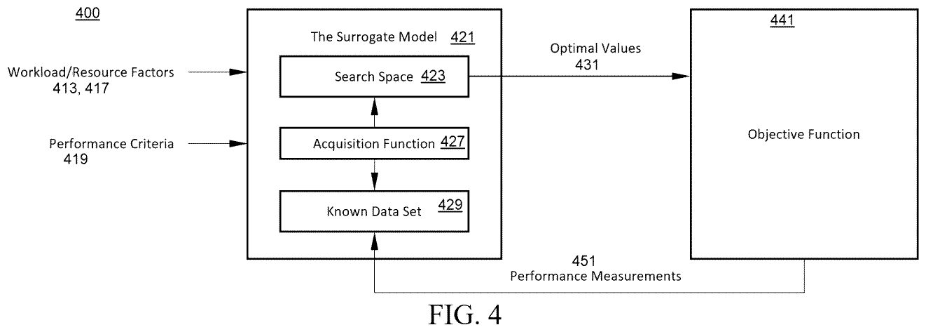

FIG. 4 illustrates various aspects of the operation of the performance model 400 in various examples herein. As illustrated in FIG. 4, the performance model 400 includes a surrogate model 421, which comprises a search space 423, an acquisition function 427, and a known data set 429. The inputs into the surrogate model 421 are workload factors 413 and/or resource factors 317 as well as performance criteria 419. The acquisition function 427 (generated by the program code), identifies configurations related to the one or more factors (e.g., workload and/or resource configurations) from the search space 423 and selects configurations as optimal values 431 in a next loop. The optimal values 431 are inputs to the objective function 441, which measures actual performance, as performance measurements 451, based on the optimal values 431. The program code of the objective function 441 provides the performance measurements 451 to the surrogate model 421, as a known data set 429 (or updating the known data set 429). FIG. 4 illustrates the iterative nature of this process as the iterations pictured can continue until a stopping criterion is reached.

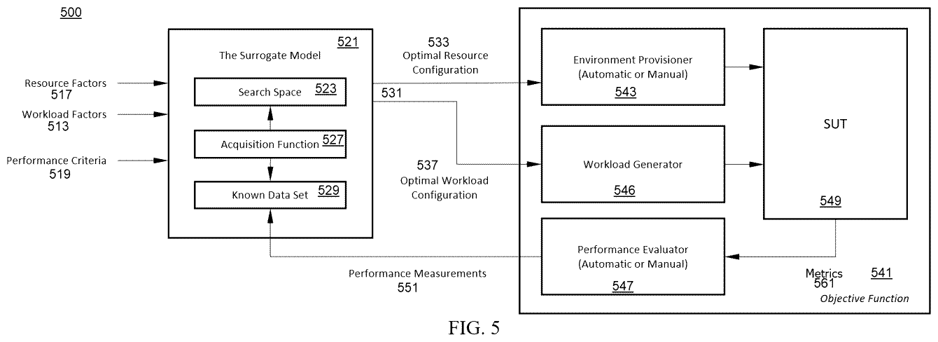

FIG. 5 illustrates the operation of the performance model 500 but provides additional details of the objective function 541, which includes, in this example, an environmental provisioner 543 (which can be automatic or manual), a workload generator 546, a performance evaluator 547, and instances 549 (generated by the program code of the environmental provisioner 543) for a system under test (SUT). The performance model 500 includes various functionalities, which are separated into components for illustrative purposes in FIG. 5. These various functionalities can be contained in one or more components and FIG. 5 provides a non-limiting example of a possible configuration. As also noted in FIG. 4 and illustrated in FIG. 5, the objective function 441 541 obtains optimal values 431 531 from a surrogate model 421 521. In the example of the performance model 500 in FIG. 5, the optimal values 531 include optimal resource configurations 533 and optimal workload configurations 537. The program code of the surrogate model 521 is optimized for performance prediction by generating resource/workload pairs (e.g., optimal resource configurations 533 and optimal workload configurations 537). The program code of the surrogate model 521 provides these optimal values 531 to program code of an environment provisioner 543 and program code of a workload generator 546, which are parts of the objective function 541. The program code of the environment provisioner 543 and program code of the workload generator 546 consume the optimal values 531. The objective function 541 also includes a performance evaluator 547, which obtains performance metrics 561 from an SUT instance 549.

As illustrated in FIG. 5, the inputs into the surrogate model 521 are resource factors 517, workload factors 513, performance criteria 519, and performance measurements 551. The surrogate model 521 outputs (or the program code comprising the model outputs) optimal values 531 which include a next (because the model is iterative) optimal resource configuration 533 for program code of an environment provisioner 543 (of the objective function 541) to consume, and a next optimal workload configuration 537 for program code of a workload generator 546 (of the objective function 541) to consume. In the objective function 541, program code of the environment provisioner 543 reads a resource configuration 533 generated by the program code of the surrogate model 521 and utilizes the resource configuration 533 to provision an SUT instance 549. The resource configuration 533 obtained by the program code of the environment provisioner 543 can include configuration information including but not limited to, a number of nodes and the CPU and/or memory on each node. Based on these data, the program code of the environment provisioner 543 generates an SUT instance 549 for performance testing. The program code of the workload generator 546 reads an optimal workload configuration 537 generated by the program code of the surrogate model 521 and based on the workload configuration 537, generates a desired workload. In some examples, the workload configuration 537 includes a set of nested entries describing variant workload aspects. The program code of the workload generator 546 generates actual workloads against the SUT instance 549. The performance evaluator 547 (in the objective function 541) obtains metrics 561 from the SUT instance 549, evaluates the system performance, and based on the evaluation, sends performance measurements 551 to the surrogate model 521. The program code of the surrogate model 521 utilizes the performance measurements 551, which it retains in a known data set 529, to determine the next optimal values 531. The performance measurements 551 indicate to the surrogate model 521 how the SUT instance 549 performs with the specified resource/workload configurations. Thus, via the performance measurements 551, the performance evaluator 547 updates the model dataset 529, to optimize the performance model 500 itself, including the surrogate model 521. This optimization (process) can continue iteratively until a stopping criterion is reached.

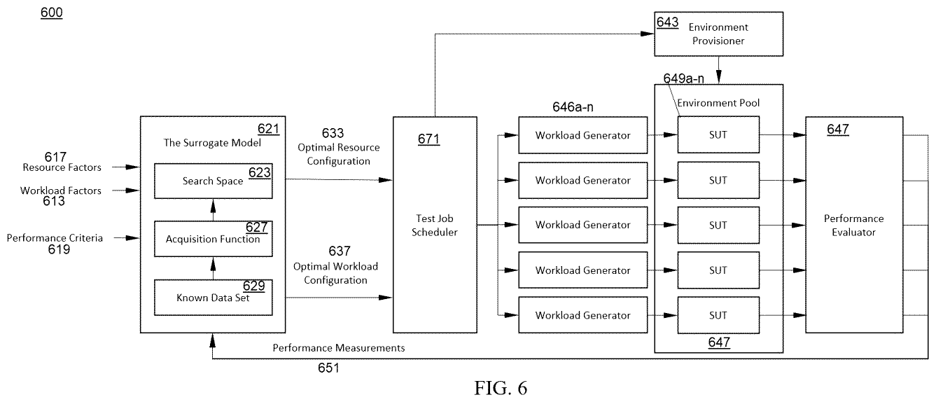

FIG. 5 illustrates an example of the performance model 500 where only one optimal resource configuration 533 and one optimal workload configuration 537 are utilized to generate an SUT instance 549 and test the SUT instance 549, but in some examples, the program code of the performance model generates multiple resource/workload configurations at once as next optimal values, so the program code can execute multiple tests and make multiple evaluations of these test results, in parallel. FIG. 6 illustrates a performance model 600 with this functionality.

As illustrated in FIG. 6, the performance model 600 includes the surrogate model 621, a test job scheduler 671, and a performance evaluator 647. The program code of the surrogate model 621 generates workload configurations 637 and resource configurations 633 (e.g., optimal configurations) and the program code of the test job scheduler 671 provides the workload configurations 637 and resource configurations 633 to the program code of various workload generators 546a-n, which generate actual workloads against SUT instances 649a-649n. Generally, the test job scheduler 671 obtains multiple optimal resource/workload configurations 633 637 (generated by the program code of the surrogate model 621) and generates test job pairs including references to the resource and workload configuration to be executed in each instance.

The test job scheduler 671 operates based on defined directions in policies provided to the performance model 600. Program code comprising a model building operator can search optimal configurations (e.g., workload configurations 637 and resource configurations 633) for a workload or resource type in a range determined by minimum and maximum values or a list of pre-defined values, for example, when it has categorical or discrete nature. The program code of the model building operator can utilize search policies to guide the model building. The search policies, for example, can guide the model building operator when searching for a next optimal configuration. Various policies can be utilized by the program code provided there is no conflict. For example, the program code can run different workloads with the same resource configuration against the same SUT instances 649a-n to maximize the use of allocated resources. The program code can also run workload and resource configurations based on a type of workload, specified by workloads, and/or with different values, against the SUT instance 649a-n, incrementally.

As illustrated in FIG. 6, the program code of the surrogate model 621 provides multiple workload configurations 637 and resource configurations 633 to a test job scheduler 671. In some examples, one can configure the number of configurations. Program code of the test job scheduler 671 schedules each workload to a qualified SUT instance 649a-n by following the policies, including those outlined above. In some examples, the test job scheduler 671 can be understood to be similar to a pod scheduler in Kubernetes, which can schedule the workload (e.g., the pod), to a qualified node. The resources configurations (e.g., workload configurations 637 and resource configurations 633) generated by the surrogate model 621 can also guide program code of an environment provisioner 643 when the program code of the environment provisioner 643 sets up corresponding SUT instances 649a-649n. The instances can be specific to the resource (e.g., software, hardware, application) that the administrator is looking to deploy (and hence understand the impacts and optimal configurations for resources in the technical environment before deployment). In some examples, the provision of environments is handled manually but the operator can utilize the same set of configurations to guide the operator's manual provision of the SUT instances 649a-649n in the environmental pool 647.

The program code of the surrogate model 621 (e.g., a black-box model) generates the workload configurations 637 and resource configurations 633 while each test job is generated by the test job scheduler 671 to pair the workload with the resource, so each workload generator 646a-n can be run against one SUT instance 649a-649n. Aspects of the configurations can include, but are not limited to: 1) references to a resource and workload configuration via a configuration identifier; 2) an environment status and a host populated by an environment provisioner (so the workload generator knows where and when to connect an SUT instance); and 3) a workload status populated by workload generator (so the test job scheduler knows when to assign new job to workload generator who finished the last job run).

The program code of the performance evaluator 647 utilize a performance evaluating configuration to define the manner in which the program code of the performance evaluator 647 evaluates the performance of an SUT instance 649a-n. The performance evaluating configuration defines a list of metrics which the program code of the performance evaluator 647 obtains from the SUT instance 649a-n. In some examples, each metric has attributes, including not limited to, names, descriptions, value types, and ranges with minimum and maximum values. The program code utilizes the attributes of the metrics for value normalization and/or a weight to calculate the performance score using Equation 1.

$$Sp = {\sum }_{i = 1}^{n} wi \times \frac{( mi - m [ min ] i )}{( m [ max ] i - m [ min ] i )} \qquad ( Equation 1 )$$

The program code can produce a single value that accurately reflects the overall performance of the SUT instance 649a-649n, considering all the relevant performance metrics. The program code of the performance evaluation can work as the objective function with a score as the returned value of the function to guide the program code of the model building operator to evaluate the optimal configurations. The default performance evaluator is based on a linear model as above, which can be replaced by a custom implementation, in some examples. The program code generates a performance evaluating result based on the metrics collected from a SUT instance 649a-649n by the program code of the performance evaluator 647. The result can include the metrics with the values, and the score calculated based on Equation 1. This result, illustrated as performance measurements 651 in FIG. 6 is transmitted to the program code of the model building operator and utilized by this program code to evaluate the optimal configurations it selects in the previous stage (e.g., the resource 633 and workload 637 configurations.

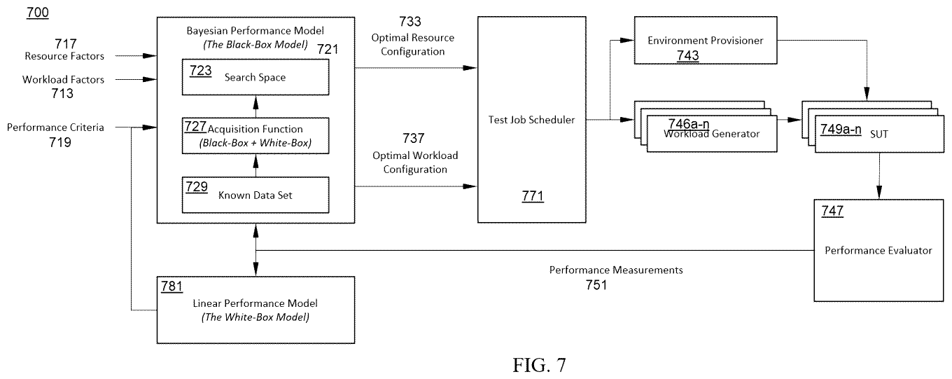

In some of the examples herein, a performance white-box model configuration is used by the program code to embed white-box knowledge into the performance model 600 to help the program code of the model building operator build the model 600 more quickly and accurately. The use of a dual model (e.g., white-box and black box) is illustrated in FIG. 7. Not all examples include this white-box model configuration because whether one can utilize a white-box model is dependent on whether there exists white-box knowledge about the SUT. Thus, if there is no existing knowledge to utilize, the performance model can be a black-box model. Provided, the white-box knowledge is available, the performance white-box model configuration portion of the performance model 600 can include a selected list of metrics which are known to be impacted by some factors defined in the performance black-box model configuration. In these examples, these metrics comprise attributes, including, but not limited to, names, descriptions, value types, and ranges with minimum and maximum values, for value normalization. The metrics can also include a list of coefficients for the corresponding factors, along with an intercept and error term to produce a metric value based on a linear model. When the program code calculates the metric value, the program code obtains actual factor values from the resource 633 and workload configurations 637 generated by the model building operator. If there are multiple metrics, the program code can calculate and sum these values as a contribution to the acquisition function 627 to guide its search for the optimal configurations (e.g., 633, 637). In some examples, the program code does not obtain one or more of the coefficient, intercept, and/or error term values. In this case, the program code can auto-populate these values when model building. When the program code feeds the resource configuration 633, the workload configuration 637, and actual metrics collected from SUT (e.g., FIG. 5, 561) into Equation 1, the program code, utilizing Equation 1, will produce the coefficient, intercept, error term values.

The program code of the test job scheduler 671 directs the provision of test environments and the execution of tests in those environments. The program code obtains the configurations (633, 637) from the surrogate model 621 and generate test job pairs. The test job scheduler 671 transmits the test job pairs to program code of an environment provisioner 643 (or the program code of the environment provisioner 643 otherwise obtains the pairs) and the program code of the environment provisioner 643 reserves an SUT instance 649a-649n (e.g., from an environment pool), or launch a new instance if there is no existing instance is qualified (based on the requirements of the configurations). The test job pairs (e.g., resource/workload pairs) include a workload configuration. The test job scheduler 671 transmits the test job pairs to program code of a workload generator 646a-n (or the program code of the workload generator 646a-n otherwise obtains the pairs) and based on the workload configuration in a pair, the program code of a given workload generator 646a-n will generate the actual workload that reflects the configuration and start a test against the corresponding SUT instance 649a-n to perform an actual performance evaluation.

As aforementioned, some examples include elements of both a black-box and a white-box model and the performance model 700 of FIG. 7 is a non-limiting example of this configuration/architecture. As illustrated in FIG. 7, program code executing on one or more processors provides white-box knowledge to a black-box model based on Bayesian Optimization by adding this white-box knowledge to the acquisition function 727. The program code of the acquisition function 727 guides a search for the next optimal values in the search space 723. The acquisition function 727 can include a combination of a Gaussian Process Regressor with the white-box knowledge using a linear model 781. The program code generates the linear model 781 utilizing known relationships between the factors (e.g., the x arguments), and the system performance determined by these factors. The white-box models supply hyper parameters and if they have not been determined by the program code (or otherwise provided) in advance of the program code generating the model, the program code can resolve these parameters during the time when the program code builds the performance model. Thus, in some examples, the acquisition function 727 is not fixed, but instead, it will be improved by tuning the white-box piece, including iteratively, (e.g., utilizing Equation 1), and the white-box piece can help the convergence of the search process more quickly, when the white-box model becomes more confident (e.g., well-tuned).

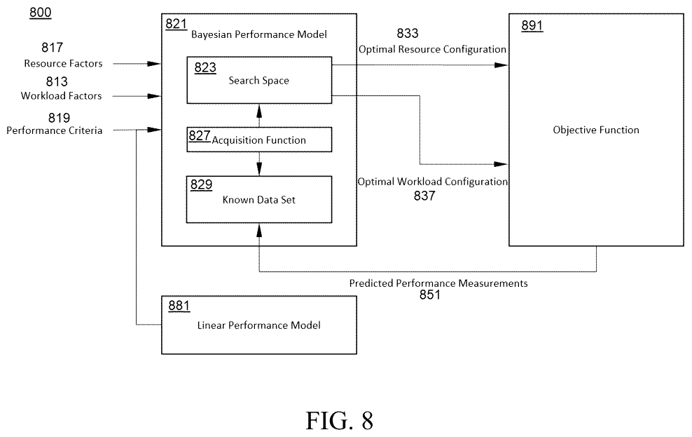

Once the performance model is optimized by the program code (and through iteratively applying the model), the program code can apply the model suggest the optimal factors values without running the actual SUT instances and instead by applying an objective function to predict the performance measurements. FIG. 8 is an example of a performance model 800 that includes this objective function 891. In this example (as in the other figures), a user can input resource factors 817, workload factors 813, and performance criteria 819, which are obtained by the program code of the model, which comprises the surrogate model 821, which is a Bayesian performance model in this example, and a linear performance model 881. The program code of the acquisition function 827 can suggest the next optimal values (optimal resource configuration 833 and optimal workload configuration 837) for the factors and pass these values into the program code of the objective function 891, which generates the predicted performance results (e.g., measurements) 851. The program code adds the results 851 to the know data set 829 to update the model 800, impacting the acquisition function 827 in the next loop. The program code of the performance model 800 iterates this process until the program code identifies a satisfactory set of input factors for the performance criteria 819.

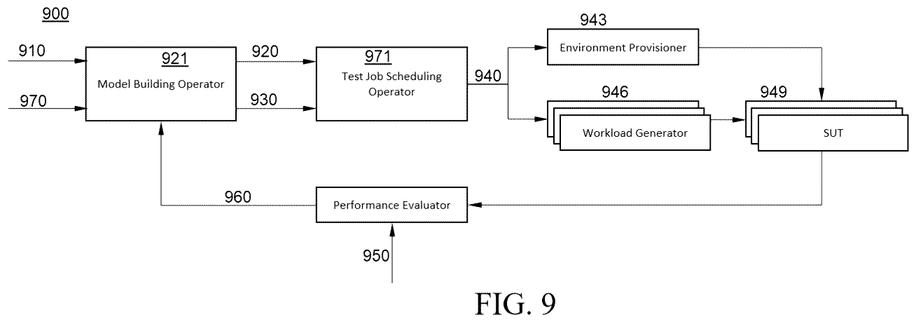

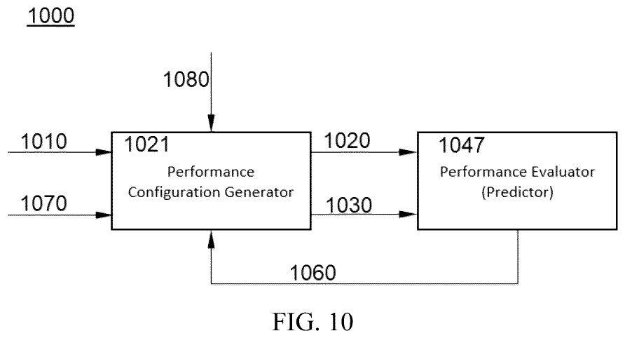

FIG. 9 illustrates a data flow 900 when program code (executing on one or more processors) builds an example of the performance model described herein. FIG. 10 illustrates a data flow 1000 when program code (executing on one or more processors) utilizes an example of the performance model described herein. For ease of understanding, both FIGS. 9-10 utilize portions of earlier figures and the labels previously assigned to various parts of the examples of the performance model described herein (e.g., the trailing digits are the same). Thus, FIGS. 9-10 illustrate elements of examples of the model itself but focus of the data flow 900 1000.

Referring to FIG. 9, in this data flow 900, the program code obtains data to enable the program code to configure the black box model (e.g., a surrogate model 921) (910). The program code applies the configured model to generate one or more optimal resource configurations (e.g., based on workload/resource factors and possibly performance criteria) (920). The program code configures workloads to execute tests on SUT instances in accordance with various configurations generated based on applying the model (930). The program code applies a scheduler 971 to generate and schedule test jobs (940). Program code obtains performance criteria to utilize to evaluate metrics obtained from the SUT instances when the program code executes the test jobs in these instances (950). Program code obtains metrics from the test executions in the SUT instances and utilizes the performance criteria to evaluate the output from the tests, generates performance measurements and updates the kind data set in the model with the performance measurements (960). The program code obtains hyper parameters in advance of the program code generating the model from a white-box (transparent) process (970). As illustrated in FIG. 10 (for ease of understanding as FIG. 10 illustrates the use of the model), the program code updates the program code of the model utilized to select configurations with the white-box data (1080).

Once the model has been configured, the program code can apply it and achieve more accurate results (the process is iterative, so it was also applied while it was tuned). FIG. 10 includes some of the same aspects of FIG. 9 but is illustrated differently to provide clarity to the data flow 1000 during the use of the model. As illustrated in FIG. 10, the program code obtains data (e.g., workload/resource factors and possibly performance criteria) to enable the program code to configure the black box model (e.g., a surrogate model 1021) (1010). The program code applies the configured model to generate one or more optimal resource configurations (e.g., based on workload/resource factors) (providing them to a program code of a performance evaluator 1047) (1020). The program code generates workload configurations based on the performance criteria (providing them to a program code of a performance evaluator 1047) (1030). Program code utilizes the performance criteria to evaluate metrics generated by the program code of a performance evaluator (1060). The program code obtains hyper parameters in advance of the program code generating the model from a white-box (transparent) process (1070). The program code updates the program code of the model utilized to select configurations with the white-box data (1080). The model can be updated with the white-box data as well as the black-box data at the same time or in any sequence.

In the examples herein, the environment provisioner and/or workload generator can be general or specific to a certain resource (e.g., application). The examples herein provide a common interface for an application to integrate with the examples herein. As the common interface, it defines a set of specifications (e.g., resource configuration and workload configuration) which the program code of the examples herein can recognize and consumed, utilizing, for examples, an application-specific environment provisioner and workload generator.

Embodiments of the present invention include computer-implemented methods, computer program products, and computer systems, where program code executing on one or more processors predicts optimal configurations for deploying a given resource in a computing environment. In some of these examples, the program code obtains one or more factors relevant to the given resource. The program code determines relationships between the one or more factors. Based on parameters comprising the relationships, the program code identifies, from a search space, one or more configurations for at least one resource and one or more configurations for at least one workload in the computing environment. The program code executes, based on a pre-defined policy, a test. The test executes a workload configured according to a configuration of the one or more for the at least one workload in a system under test instance configured according to a configuration of the one or more configurations for at the least one resource. The program code obtains performance measurements for the test in the system under test instance. The program code utilizes the performance measurements to update a known data set.

In some examples, the parameters further comprise the known data set.

In some examples, the parameters further comprise hyper-parameters reflecting how the computing environment performs in when the one or more factors comprise specific values.

In some examples, the program code applies a linear regression on known performance criteria to derive the hyper-parameters.

In some examples, based on parameters comprising the relationships and the known data set, the program code identifies, from the search space, an additional one or more configurations for the at least one resource and an additional one or more configurations for the at least one workload in the computing environment. The program code executes, based on the pre-defined policy. The program code obtains additional performance measurements for the test in the system under test instance. The program code determines, based on the additional performance measurements, if a pre-defined stopping criteria have been reached.

In some examples, based on the program code determining that the pre-defined stopping criteria have been reached, the program code identifies a configuration of the additional one or more configurations for the at least one resource and a configuration of the additional one or more configurations for the at least one workload meeting the pre-defined stopping criteria. The configuration of the additional one or more configurations for the at least one resource and the configuration of the additional one or more configurations for the at least one workload meeting the pre-defined stopping criteria comprise an optimal workload configuration and an optimal resource configuration.

In some examples, the program code implements the optimal workload configuration and the optimal resource configuration when deploying the given resource in the computing environment.

In some examples, based on the program determining that the pre-defined stopping criteria have not been reached, the program code updates the known data set with the additional performance measurements. The program code iteratively executes a process until the pre-defined stopping criteria have been reached, the process includes various aspects. For example, based on parameters comprising the relationships and the known data set. Also, the program code identifies, from the search space, another one or more configurations for the at least one resource and another one or more configurations for the at least one workload in the computing environment. The program code executes, based on the pre-defined policy, the test. The program code obtains other performance measurements for the test in the system under test instance. Finally, in the process, the program code determines, based on the other performance measurements, if a pre-defined stopping criteria have been reached.

In some examples, the program code executing the test further comprises: the program code provisioning one or more system under test instance based on the system under test instance according to the configuration of the one or more configurations for at the least one resource.

In some examples, the program code provisioning comprises the program code provisioning at least one system under test instance for each configuration of the one or more configurations for at the least one resource, and the program code scheduling the test in each system under test instance, where at least two tests run in parallel.

In some examples, the program code executing the test based on the pre-defined policy, comprises the program code applying an objective function to predict the performance measurements.

In some examples, the one or more factors relevant to the given resource are selected from the group consisting of: resource factors, workload factors, and performance criteria.

In some examples, the one or more factors comprise resource factors and the resource factors are selected from the group consisting of: number of nodes, number of pods, computer processing units, and number of memory units.

In some examples, the one or more factors comprise workload factors and the workload factors are selected from the group consisting of: number of entities, number of spans, and number of metrics.

In some examples, the one or more factors comprise performance criteria and the performance criteria are selected from the group consisting of: response time, throughput, and error rate.

In some examples, the given resource is a software application.

In some examples, the at least one workload comprises a workload of the given resource and the at least one resource would execute the given resource after deployment of the given resource in the computing environment.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of predicting optimal configurations for deploying a given resource in a computing environment, the method comprising:
obtaining, by one or more processors, one or more factors relevant to the given resource;
determining, by the one or more processors, relationships between the one or more factors;
based on parameters comprising the relationships, identifying, by the one or more processors, from a search space, one or more resources configurations for at least one resource and one or more workload configurations for at least one workload in the computing environment;
executing, by the one or more processors, based on a pre-defined policy, a test, wherein the test executes a workload configured according to a workload configuration of the one or more workload configurations for the at least one workload in a system under a test instance configured according to a resource configuration of the one or more resource configurations for the at least one resource;
obtaining, by the one or more processors, performance measurements for the test in the system under test instance; and
utilizing, by the one or more processors, the performance measurements to update a known data set.

2. The computer-implemented method of claim 1, wherein the parameters further comprise the known data set.

3. The computer-implemented method of claim 1, wherein the parameters further comprise hyper-parameters reflecting how the computing environment performs in when the one or more factors comprise specific values.

4. The computer-implemented method of claim 3, further comprising:
applying, by the one or more processors, a linear regression on known performance criteria to derive the hyper-parameters.

5. The computer-implemented method of claim 1, further comprising:
based on the parameters comprising the relationships and the known data set, identifying, by the one or more processors, from the search space, a first additional one or more resources configurations for the at least one resource and a second additional one or more workload configurations for the at least one workload in the computing environment;
executing, by the one or more processors, based on the pre-defined policy, the test;
obtaining, by the one or more processors, additional performance measurements for the test in the system under test instance; and
determining, by the one or more processors, based on the additional performance measurements, if pre-defined stopping criteria have been reached.

6. The computer-implemented method of claim 5, further comprising:
based on determining that the pre-defined stopping criteria have been reached, identifying, by the one or more processors, a given resource configuration of the additional one or more resource configurations for the at least one resource and a given workload configuration of the additional one or more workload configurations for the at least one workload meeting the pre-defined stopping criteria, wherein the given resource configuration of the additional one or more resource configurations for the at least one resource and the given workload configuration of the additional one or more workload configurations for the at least one workload meeting the pre-defined stopping criteria comprise an optimal workload configuration and an optimal resource configuration.

7. The computer-implemented method of claim 6, further comprising:
implementing, by the one or more processors, the optimal workload configuration and the optimal resource configuration when deploying the given resource in the computing environment.

8. The computer-implemented method of claim 5, further comprising:
based on determining that the pre-defined stopping criteria have not been reached, updating, by the one or more processors, the known data set with the additional performance measurements; and
iteratively executing a process until the pre-defined stopping criteria have been reached, the process comprising:
based on the parameters comprising the relationships and the known data set, identifying, by the one or more processors, from the search space, another one or more resource configurations for the at least one resource and another one or more workload configurations for the at least one workload in the computing environment;
executing, by the one or more processors, based on the pre-defined policy, the test;
obtaining, by the one or more processors, other performance measurements for the test in the system under test instance; and
determining, by the one or more processors, based on the other performance measurements, if the pre-defined stopping criteria have been reached.

9. The computer-implemented method of claim 1, wherein executing the test further comprises:
provisioning, by the one or more processors, one or more system under test instances based on the system under test instance according to the resource configuration of the one or more resource configurations for at the least one resource.

10. The computer-implemented method of claim 9, wherein the provisioning comprises provisioning at least one system under test instance for each resource configuration of the one or more resource configurations for at the least one resource; and
scheduling, by the one or more processors, the test in each system under test instance, wherein at least two tests run in parallel.

11. The computer-implemented of claim 1, wherein executing the test based on the pre-defined policy, comprises applying, by the one or more processors, an objective function to predict the performance measurements.

12. The computer-implemented method of claim 1, wherein the one or more factors relevant to the given resource are selected from the group consisting of: resource factors, workload factors, and performance criteria.

13. The computer-implemented method of claim 12, wherein the one or more factors comprise resource factors and the resource factors are selected from the group consisting of: number of nodes, number of pods, computer processing units, and number of memory units.

14. The computer-implemented method of claim 12, wherein the one or more factors comprise workload factors and the workload factors are selected from the group consisting of: number of entities, number of spans, and number of metrics.

15. The computer-implemented method of claim 12, wherein the one or more factors comprise performance criteria and the performance criteria are selected from the group consisting of: response time, throughput, and error rate.

16. The computer-implemented method of claim 1, wherein the given resource is a software application.

17. The computer-implemented method of claim 1, wherein the at least one workload comprises a workload of the given resource and the at least one resource would execute the given resource after deployment of the given resource in the computing environment.

18. A computer system for predicting optimal configurations for deploying a given resource in a computing environment, the computer system comprising:
a memory; and
one or more processors in communication with the memory, wherein the computer system is configured to perform a method, said method comprising:
obtaining, by the one or more processors, one or more factors relevant to the given resource;
determining, by the one or more processors, relationships between the one or more factors;
based on parameters comprising the relationships, identifying, by the one or more processors, from a search space, one or more resources configurations for at least one resource and one or more workload configurations for at least one workload in the computing environment;
executing, by the one or more processors, based on a pre-defined policy, a test, wherein the test executes a workload configured according to a workload configuration of the one or more workload configurations for the at least one workload in a system under a test instance configured according to a resource configuration of the one or more resource configurations for the at least one resource;
obtaining, by the one or more processors, performance measurements for the test in the system under test instance; and
utilizing, by the one or more processors, the performance measurements to update a known data set.

19. The computer system of claim 18, the method further comprising:
based on the parameters comprising the relationships and the known data set, identifying, by the one or more processors, from the search space, a first additional one or more resources configurations for the at least one resource and a second additional one or more workload configurations for the at least one workload in the computing environment;
executing, by the one or more processors, based on the pre-defined policy, the test;
obtaining, by the one or more processors, additional performance measurements for the test in the system under test instance;
determining, by the one or more processors, based on the additional performance measurements, if pre-defined stopping criteria have been reached;
based on determining that the pre-defined stopping criteria have been reached, identifying, by the one or more processors, a given resource configuration of the additional one or more resource configurations for the at least one resource and a given workload configuration of the additional one or more workload configurations for the at least one workload meeting the pre-defined stopping criteria, wherein the given resource configuration of the additional one or more resource configurations for the at least one resource and the given workload configuration of the additional one or more workload configurations for the at least one workload meeting the pre-defined stopping criteria comprise an optimal workload configuration and an optimal resource configuration.

20. A computer program product for predicting optimal configurations for deploying a given resource in a computing environment, the computer program product comprising:
one or more computer readable storage media and program instructions collectively stored on the one or more computer readable storage media readable by at least one processing circuit to:
obtain, by the one or more processors, one or more factors relevant to the given resource;
determine, by the one or more processors, relationships between the one or more factors;
based on parameters comprising the relationships, identify, by the one or more processors, from a search space, one or more resources configurations for at least one resource and one or more workload configurations for at least one workload in the computing environment;
execute, by the one or more processors, based on a pre-defined policy, a test, wherein the test executes a workload configured according to a workload configuration of the one or more workload configurations for the at least one workload in a system under a test instance configured according to a resource configuration of the one or more resource configurations for the at least one resource;
obtain, by the one or more processors, performance measurements for the test in the system under test instance; and
utilize, by the one or more processors, the performance measurements to update a known data set.
